(19) United States
(12) Patent Application Publication
(10) Pub. No.: US 2014/0325602 A1
(43) Pub. Date: Oct. 30, 2014

(54) ACCESSING SYSTEM FOR VEHICLE NETWORK AND METHOD OF CONTROLLING THE SAME

(71) Applicant: Hyundai Motor Company, Seoul (KR)

(72) Inventors: Soon Woo KWON, Uiwang-si (KR); Seung Bum RYU, Anyang-si (KR); Pil Yong PARK, Seoul (KR); Jeong Min KIM, Suwon-si (KR)

(73) Assignee: Hyundai Motor Company, Seoul (KR)

(21) Appl. No.: 14/015,533

(22) Filed: Aug. 30, 2013

(30) Foreign Application Priority Data
Apr. 29, 2013 (KR) 10-2013-0047354

(51) Int. Cl. H04L 29/06

(52) U.S. Cl. CPC H04L 63/08
USPC 726/4

(57) ABSTRACT

A system for accessing to vehicle network includes a gateway extracting requested information from an in-vehicle network to transfer to an external device when an information request of the external device is a pre-registered inspect request and outputting a selection signal for a sector which an authenticated external device requested after performing an authentication for the external device when the information request is not the pre-registered inspect request. The system further includes a signal transmitter connecting the external device with the in-vehicle network corresponding to the sector that the external device requests when the selection signal is received from the gateway.

### CROSS-REFERENCE TO RELATED APPLICATION

This application claims priority to and the benefit under 35 U S. C. §119 (a) of Korean patent application filed in the Korean Intellectual Property Office on Apr. 29, 2013 and assigned Serial No. 2013-0047354, and the entire disclosure of which is hereby incorporated by reference.

### TECHNICAL FIELD

The present disclosure relates to an accessing system for a vehicle network and a method of controlling the same, and more particularly, to an accessing system for a vehicle network in which an external device authenticated according to an in-vehicle network enables transmitting and receiving data without passing through a gateway, and a method of controlling the same.

### BACKGROUND

Generally, a vehicle control interface is installed in a vehicle to support communication between a vehicle network and various information-telecommunication devices such as a vehicle diagnosis device, a personal digital assistance (PDA), a note book computer, and the like. The vehicle control interface includes communication protocols such as CAN (ISO 1158), UART, SAE J1850, and the like and may be connected to an electronic control unit (ECU) configuring the vehicle network through a state machine, a media access controller (MAC), and the like of each communication protocol. The vehicle control interface may also be included in a vehicle gateway.

The vehicle gateway prevents an external device from being directly connected to an in-vehicle network and may function as a firewall to transmit reliable requests to the in-vehicle network.

The method of approaching through the vehicle gateway is strongly advantageous for an external hacking, but when examining a specific sector of the in-vehicle network such as after sales service (A/S), it is difficult to detect.

In addition, even with reliable data, since corresponding data is processed and transferred in a micom of the gateway, there is a time difference compared to the real time of the vehicle. Accordingly, a problem may occur due to the performance of the gateway at the time of A/S.

### SUMMARY

The present disclosure has been made in view of the above problems, and provides an accessing system to a vehicle network which transfers data by accessing the vehicle network without passing through a gateway as an external device.

According to an embodiment of the disclosure, a system for accessing to a vehicle network includes a gateway extracting requested information from a corresponding unit of an in-vehicle network to transfer to an external device when an information request of the external device is a pre-registered inspect request, and outputting a selection signal for a sector which an authenticated external device requested after performing an authentication for the external device when the information request is not the pre-registered inspect request. A signal transmitter connects the external device with the in-vehicle network corresponding to the sector that the external device requests when the selection signal is received from the gateway.

A system for accessing to vehicle network may further include an external transceiver providing a connecting path for transmitting and receiving data between the external device and the gateway or the signal transmitter. An internal transceiver provides a connecting path for transmitting and receiving data between the in-vehicle network and the gateway or the signal transmitter. The gateway transmits a first authentication key to the corresponding external device when the monitoring request is received from the external device and performs a verification process by receiving a second authentication key converted from the first authentication key from the external device to perform an authentication for the external device. The signal transmitter enables the external device to directly connect to a data bus of the in-vehicle network.

In accordance with embodiment of the disclosure, a method of controlling an accessing system for a vehicle network includes: determining whether a received information request from an external device is a pre-registered inspect request, extracting requested information from an in-vehicle network to transfer to the external device if the information request is the pre-registered inspect request, and performing an authentication procedure for the external device if the information request is not the pre-registered inspect request. The external device connected to the in-vehicle network corresponding to an authenticated external device. The authentication procedure for the external device includes: transmitting a first authentication key to the corresponding external device when a monitoring request is received from the external device; receiving a second authentication key converted from the first authentication key from the external device; and verifying the second authentication key. Connecting the external device to the in-vehicle network comprises directly connecting the external device to a data bus.

### BRIEF DESCRIPTION OF THE DRAWINGS

The objects, features and advantages of the present disclosure will be more apparent from the following detailed description in conjunction with the accompanying drawings, in which:

FIG. 1 is a block diagram illustrating a configuration of a gateway system according to an exemplary embodiment of the present disclosure; and

FIG. 2 is a flow chart illustrating a method of controlling an access to an accessing system for a vehicle network according to an exemplary embodiment of the present disclosure.

### DETAILED DESCRIPTION

Exemplary embodiments of the present disclosure are described in detail with reference to the accompanying drawings. The same reference numbers are used throughout the drawings to refer to the same or like parts. Detailed descriptions of well-known functions and structures incorporated herein may be omitted to avoid obscuring the subject matter of the present disclosure.

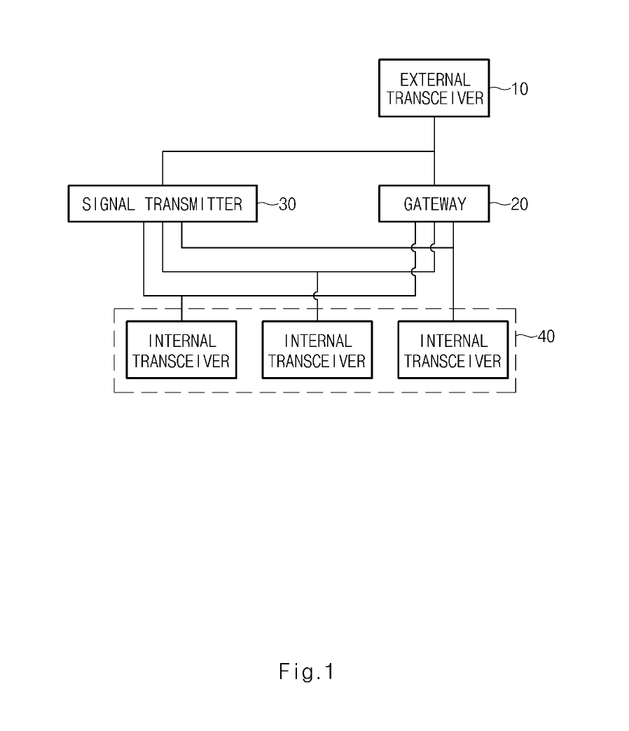

FIG. 1 is a diagram illustrating a configuration of an accessing system for a vehicle network.

An accessing system for a vehicle network includes an external transceiver 10, a gateway 20, a signal transmitter 30, and an internal transceiver 40.

The external transceiver 10, which is an interface element connecting to an external device through an accessing terminal, provides a connecting path to transmit and receive data between the external device and the gateway 20 or the signal transmitter 30. For example, when an accessing request received from the external device is a general inspect request, the external device is connected to an in-vehicle network via the gateway 20, such that the data communication operation identical with the related art is performed. On the other hand, when the accessing request received is an A/S monitoring request, the external device is directly connected to the in-vehicle network via the signal transmitter 30.

The gateway 20 transmits and receives data for requesting and obtaining vehicle information between the external device and the in-vehicle network. When the general inspection request is received via the external transceiver 10, the gateway 20 checks access privileges and effectiveness for the corresponding request and transfers only the request (a request pre-registered in a controller of the gateway) to the in-vehicle network. Further, the gateway 20 transmits corresponding information (such as vehicle state information) received to the external device. In a case of receiving the request for the A/S monitoring as a determination result, the gateway 20 commands the signal transmitter 30 to connect an authenticated external device to the in-vehicle network via separate procedure. For example, the gateway 20 transmits a selection signal for a sector to which the external device requests monitoring to the signal transmitter 30 and commands the signal transmitter 30 to connect the sector with the external device.

Since the gateway 20 transfers only a reliable specific request (the request pre-registered in a controller of the gateway) to the in-vehicle network and extracts related information to transmit to the external device, a user (for example, a mechanic) may not monitor and extract real time data.

The authenticated external device may monitor necessary information in real time by accessing to the in-vehicle network via the signal transmitter 30 without passing through the gateway. In addition, the gateway 20 performs the general function operation when the A/S monitoring is released, or a system restarting, such as starting off is performed.

The signal transmitter 30 may connect the external device to the in-vehicle network according to an instruction received from the gateway 20, and enable the external device to directly transmit and receive the data. That is, the signal transmitter 30 provides an interface path to the external device for the in-vehicle network to which the external device requests monitoring, such that the external device is directly connected to a data bus.

The internal transceiver 40, which is an interface connecting the in-vehicle network, provides a connecting path that may transmit and receive data between the in-vehicle network and the gateway 20 or the signal transmitter 30.

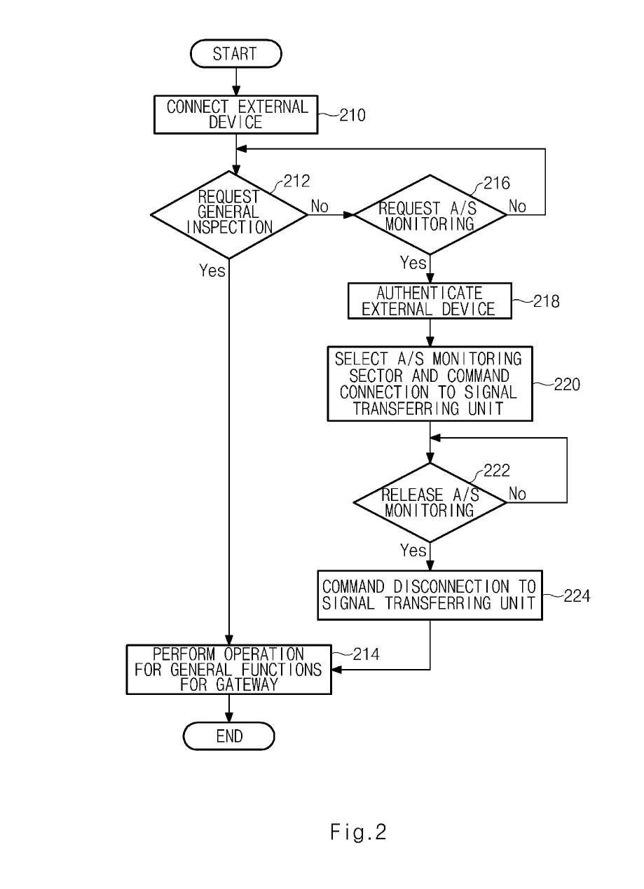

FIG. 2 is a flow chart illustrating a method of controlling an accessing system for vehicle network.

In a vehicle repair shop, an inspection device is connected to an accessing terminal to check a condition of the vehicle, such that the accessing system for the vehicle network is connected to an external device (S210) in certain embodiments.

Thus, the gateway 20 first checks whether the connected external device is for a general inspection or for A/S monitoring (S212).
The gateway 20 may check the signal requested from the connected external device and determine whether the signal received from the corresponding device is for the preset general inspection.

As a result, in a case in which the corresponding external device is for a general inspection, the gateway 20 transmits and receives data only for a specific given request similar to the related art (S214).

That is, the gateway 20 transfers only the reliable specific request signal to the in-vehicle network to extract information and serves as a firewall by transmitting the extracted information to the external device.

When the corresponding external device is for A/S monitoring at step S212, the gateway 20 performs an authentication procedure for the corresponding device (S216, S218).

After storing a pre-defined authentication code when the external device is connected, the external device may transmit the corresponding authentication code to the gateway 20. Alternatively, the gateway 20 may transmit an authentication key to the corresponding external device when A/S monitoring is requested. The external device performs a key conversion according to an agreed upon algorithm to transmit the converted authentication key such that the gateway 20 performs the verification process to authenticate the corresponding external device.

Once the authentication is successfully completed, the gateway 20 transmits a selection signal for the sector to the signal transmitter 30, such that the gateway 20 commands the signal transmitter 30 to connect the external device with the selected sector (S220).

The signal transmitter 30 with the selection signal received from the gateway 20 provides the interface path for the in-vehicle network to the external device and enables the external device to directly connect to the data bus.

As a result, the external device is directly connected to the in-vehicle network through the signal transmitter 30 without passing through the gateway 20, such that the external device may be provided with the entire data for a desired sector by transmitting and receiving the data to the external device or monitoring the corresponding real time data.

In a case in which the A/S monitoring of the corresponding external device is released or the system reboots for start-off (S222), the gateway 20 transmits a command of releasing the connection between the external device and the signal transmitter 30 (S224).

When the signal transmitter 30 is released, the gateway 20 performs a general operation (S214).

As set forth above, a general device is accessed to the network via the gateway to serve as a firewall for the external hacking and a specific external device which is authenticated is directly accessed to the in-vehicle network to transfer the data, thereby performing A/S easier and more accurate while maintaining security.

Although exemplary embodiments of the present invention have been described in detail hereinabove, it should be clearly understood that many variations and modifications of the basic inventive concepts herein taught which may appear to those skilled in the present art will fall within the spirit and scope of the present disclosure, as defined in the appended claims.

What is claimed is:

1. A system for accessing a vehicle network, the system comprising:
a gateway extracting requested information from an in-vehicle network to transfer to an external device when an information request of the external device is a pre-registered inspect request and outputting a selection signal for a sector which an authenticated external device requested after performing an authentication for the external device when the information request is not the pre-registered inspect request; and
a signal transmitter connecting the external device with the in-vehicle network corresponding to the sector that the external device requests when the selection signal is received from the gateway.

2. The system of claim 1, further comprising:
an external transceiver providing a connecting path for transmitting and receiving data between the external device and the gateway or the signal transmitter; and
an internal transceiver providing a connecting path for transmitting and receiving data between the in-vehicle network and the gateway or the signal transmitter.

3. The system of claim 2, wherein the gateway transmits a first authentication key to the corresponding external device when a monitoring request is received from the external device and performs a verification process by receiving a second authentication key converted from the first authentication key from the external device to perform an authentication for the external device.

4. The system of claim 2, wherein the signal transmitter enables the external device to directly connect to a data bus of the in-vehicle network.

5. A method of controlling an accessing system for a vehicle network, the method comprising:
determining whether a received information request is a pre-registered inspect request when the information request is received from an external device;
extracting requested information from an in-vehicle network to transfer to the external device when the information request is the pre-registered inspect request, and performing an authentication procedure for the external device when the information request is not the pre-registered inspect request; and
connecting the external device to the in-vehicle network corresponding to a sector that the external device requested when the external device is an authenticated external device.

6. The method of claim 5, wherein the authentication procedure for the external device comprises:
transmitting a first authentication key to the corresponding external device when a monitoring request is received from the external device;
receiving a second authentication key converted from the first authentication key from the external device; and
verifying the second authentication key.

7. The method of claim 5, wherein connecting the external device to the in-vehicle network comprises directly connecting the external device to a data bus.
